(19) United States
(12) Patent Application Publication
(10) Pub. No.: US 2015/0347923 A1
(43) Pub. Date: Dec. 3, 2015

(54) ERROR CLASSIFICATION IN A COMPUTING SYSTEM

(71) Applicant: International Business Machines Corporation, Armonk, NY (US)

(72) Inventors: Timothy S. Bartley, Worongary (AU); Gavin G. Bray, Robina (AU); Elizabeth M. Hughes, Currumbin Valley (AU); Kalvinder P. Singh, Miami (AU)

(21) Appl. No.: 14/468,484

(22) Filed: Aug. 26, 2014

Related U.S. Application Data
(63) Continuation of application No. 14/289,351, filed on May 28, 2014.

(51) Int. Cl. G06N 99/00; G06F 11/00

(52) U.S. Cl. CPC G06N 99/005; G06F 11/006; G06F 2201/875

(57) ABSTRACT

In an approach to determining a classification of an error in a computing system, a computer receives a notification of an error during a test within a computing system. The computer then retrieves a plurality of log files created during the test from within the computing system and determines data containing one or more error categorizations. The computer determines a classification of the error, based, at least in part, on the plurality of log files and the data containing one or more error categorizations.

### FIELD OF THE INVENTION

The present invention relates generally to the field of software computing systems, and more particularly to performing machine learning of log files produced during testing in order to classify a possible cause of an error in the system.

### BACKGROUND

Software computing systems can be very complex and can consist of many integrated parts. Software testing often is a process of executing a program or application in order to find software errors which reside in the product. The tests may be executed at unit, integration, system, and system integration levels. Testing large, complex systems is difficult and when a problem arises, a tester or developer manually tests, executes, and analyzes log files from one, or many, of the failed applications or components. Log files contain records of events which occur during testing of a component, an operating system or other software applications. Sometimes an error occurs with a different component than the one being tested, and the tester or developer has to investigate more log files or perform additional actions to determine the cause.

### SUMMARY

Embodiments of the present invention include a method, a computer program product, and a computer system for determining a classification of an error in a computing system. An embodiment includes a computer receiving a notification of an error during a test within a computing system. The computer then retrieves a plurality of log files created during the test from within the computing system and determines data containing one or more error categorizations. The computer determines a classification of the error, based, at least in part, on the plurality of log files and the data containing one or more error categorizations.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a training program for normalizing log files and categorizing errors contained in the log files, in accordance with an embodiment of the present invention.

FIG. 3 is a flowchart depicting operational steps of a reporting program for classifying errors based on the categorized log files from operation of the training program of FIG. 2 and determining a confidence score associated with the classified errors, in accordance with an embodiment of the present invention.

FIG. 4 depicts a block diagram of the internal and external components of a data processing system, such as the server computing device of FIG. 1, in accordance with an embodiment of the present invention.

### DETAILED DESCRIPTION

Embodiments of the present invention recognize that log files of failures for various components operating within a system may be viewed on one or more client computing devices in order to detect an error that may exist within a group of client machines, such as within an office or other computing system network. Users are able to inspect log files from various locations to determine a root cause for the error. Embodiments of the present invention recognize that it can become a large job for an individual tester or developer to determine the root cause or problem, and the individual may need to investigate further log files or request additional help from other testers or developers. Embodiments of the present invention recognize that problems may be diverse, including errors within a cloud computing system, network connectivity issues, failures with underlying software platforms, or problems with the product or device being tested, and that the more complex a computing system is, the more difficult it becomes to determine the root cause of an error.

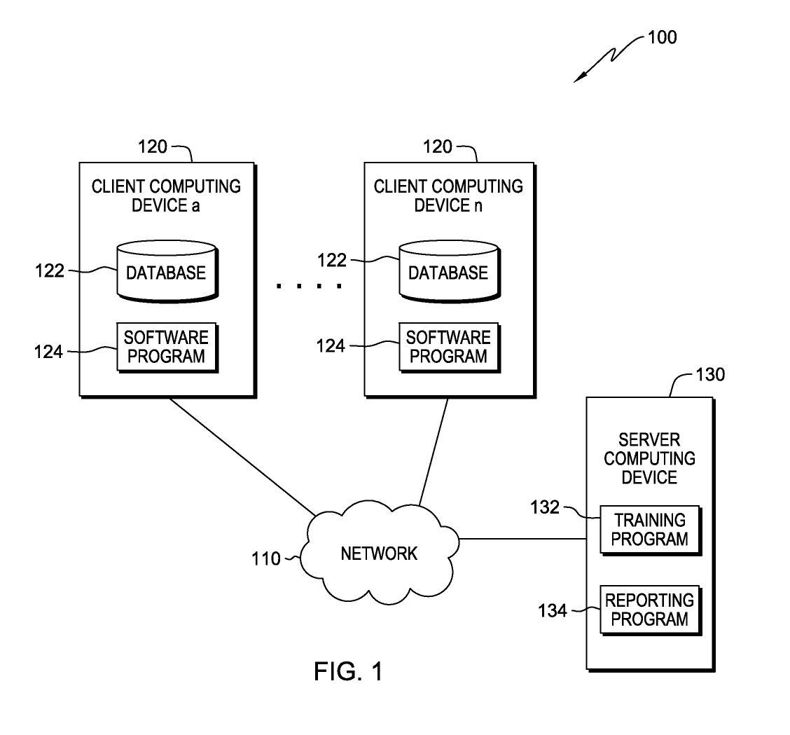

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the systems and environments in which different embodiments may be implemented. Many modifications to the depicted environment may be made by those skilled in the art without departing from the scope of the invention as recited by the claims.

Distributed data processing environment 100 includes client computing devices 120a to n, and server computing device 130, all interconnected over network 110. Network 110 can be, for example, a local area network (LAN), a telecommunications network, a wide area network (WAN) such as the Internet, or a combination of the three, and can include wired, wireless, or fiber optic connections. In general, network 110 can be any combination of connections and protocols that will support communication between client computing devices 120a to n and server computing device 130, in accordance with embodiments of the present invention.

Client computing devices 120a to n include database 122 and software program 124. Client computing devices 120a to n provide log files for events occurring within each respective device, including applications and additional components within or connected to the device. Log files can contain records of events which occur while an operating system runs or while a component is being tested. For example, if there is a failure occurring during test of a component of client computing device 120a, the log files from the device 120a should be considered to find a root cause of the error. In various embodiments of the present invention, client computing devices 120a to n can be a laptop computer, a personal digital assistant (PDA), a smart phone, or any programmable electronic device capable of communicating with each other client computing device and with server computing device 130 via network 110.

Each instance of database 122 stores log files generated by a software application or other component within each respective client computing device 120. In another embodiment, another program operating within the environment may collect log files and store them within database 122. In embodiments, software program 124 is an application under test which automatically generates log files and stores the log files within database 122. Software program 124 can be any program or application that can run on client computing devices 120a to n. In various embodiments, software program 124 can be for example, a software application, an executable file, a library, or a script. In some embodiments, log files generated during operation or test of software program 124 may be sent directly to server computing device 130 via network 110.

Server computing device 130 includes training program 132 and reporting program 134 and may be a management server, a web server, or any other electronic device or computing system capable of receiving and sending data. Alternatively, server computing device 130 can be a laptop computer, a tablet computer, a netbook computer, a personal computer (PC), a desktop computer, a PDA, a smart phone, or any programmable electronic device capable of communicating with client computing devices 120a to n via network 110, and with other various components and devices within distributed data processing environment 100. In other embodiments, server computing device 130 may represent a server computing system utilizing multiple computers as a server system, such as in a cloud computing environment. In an embodiment of the present invention, server computing device 130 represents a computing system utilizing clustered computers and components (e.g., database server computer, application server computers, etc.) that act as a single pool of seamless resources when accessed within distributed data processing environment 100.

Training program 132 retrieves log files produced during test runs within an environment, such as distributed data processing environment 100, in order to categorize any errors occurring within the environment to allow for quick identification of the root cause of an error. An environment can be considered as a number of machines, such as client computing devices 120a to n, the type of architecture for the machines, the software, and the applications or software operating on each machine, including multiple versions of the software. Training program 132 collects log files, including test run log files, product log files, and cloud log files and parses each log entry within the log files to obtain a timestamp for the entry. Log entries can be defined as a block of information, normally a line or an exception stack, within each log file. Training program 132 then normalizes each entry in the log file and categorizes the entries to create identifiers. Log files are then merged into combinations in order to keep the events within sequence. Creating individual and combinations of log files allows a machine learning algorithm to categorize errors without needing each one of the log files. While in FIG. 1, training program 132 is included within server computing device 130, one of skill in the art will appreciate that in other embodiments, training program 132 may be located within client computing devices 120a to n or elsewhere within distributed data processing environment 100 and can communicate with server computing device 130 via network 110.

Reporting program 134 determines whether an error occurs during a test run and is capable of determining a classification of the error condition based on the categorized errors in the trained data from operation of training program 132. Reporting program 134 can report possible errors with a confidence score, which represents how statistically close the current test run log files are compared to the log files used by training program 132. The confidence score is compared to a threshold value, which can be determined by a user or operator of the system. If the confidence score is high compared to the threshold, the error is reported and if it is low compared to the threshold, reporting program 134 determines whether to gather more log files, or to report the confidence score as low and allow the user to classify the error. While in FIG. 1, reporting program 134 is included within server computing device 130, one of skill in the art will appreciate that in other embodiments, reporting program 134 may be located within client computing devices 120a to n or elsewhere within distributed data processing environment 100 and can communicate with server computing device 130 via network 110.

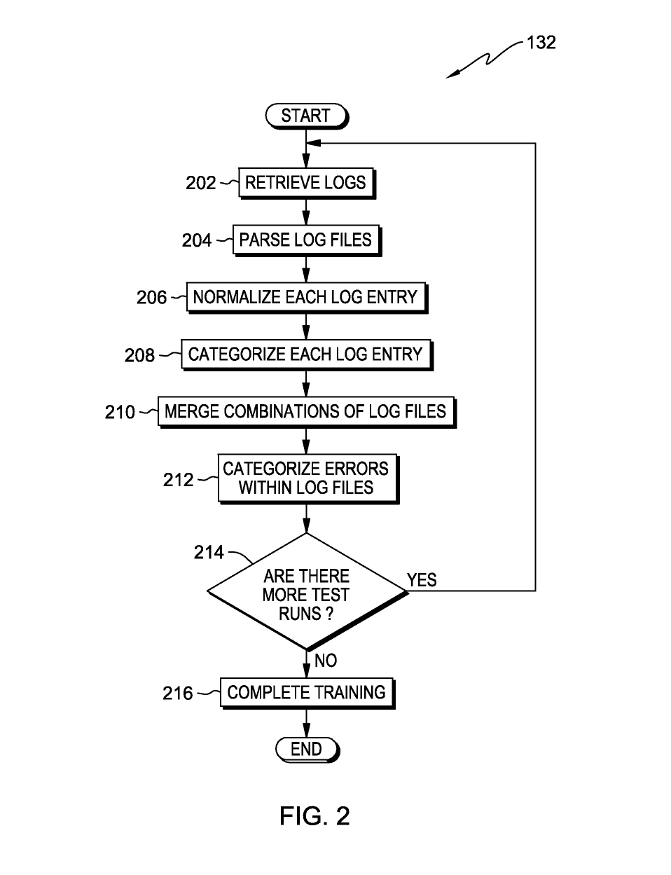

FIG. 2 is a flowchart depicting operational steps of training program 132 for normalizing log files and categorizing errors contained in the log files, in accordance with an embodiment of the present invention.

Training program 132 retrieves log files for each test run in an environment (step 202). Log files can be test case log files, product log files, or cloud log files from various applications and components within distributed data processing environment 100. In one embodiment, log files can be retrieved directly from the components and applications being tested or received by training program 132 from the components and applications within distributed data processing environment 100. In other embodiments, log files may be retrieved from database 122 via network 110.

Training program 132 parses each log file (step 204). In an embodiment, each log file is parsed to determine a timestamp for each log file entry. If a log entry does not have a timestamp, training program 132 can use known text classification mechanisms to order the log entries according to the similarity of content in the log file entries.

Training program 132 normalizes each log entry (step 206). In an embodiment, the log entries are cleaned and normalized using known methods in the art, such as using a normalization algorithm. In an example, log files can be normalized by removing or replacing IP addresses in the file. A search could be performed for a sequence of characters that contains digits and the “.” character, and the sequence can be replaced with “xxx.xxx.xxx.xxx”. As a result, for a same message output within two different runs of a test case, the same log entry will result, even though the IP addresses may have been different before the normalization. In an embodiment, once the log entries are normalized, the data may be organized into a certain format. For example, training program 132 stores the normalized log entry with an association to the original, or raw, log entry within database 122.

Training program 132 categorizes each log entry (step 208). In an embodiment, the log entries are categorized using known methods in the art, for example, machine learning algorithms such as text supervised machine learning including, for example, support vector machines (“SVM”). SVM's are supervised learning models with associated learning algorithms that analyze data and recognize patterns. For example, if there are many log entries that contain the same content, the log files containing the similar log entries can be grouped together and placed within the same category. In an alternate embodiment, unsupervised machine learning may be used, for example, known algorithms such as Density-Based Spatial Clustering of Applications with Noise (“DBSCAN”), however, the results however may not be as accurate. In embodiments, training program 132 creates identifiers for each categorized log entry using known text analysis methods, while in other embodiments a user can create identifiers for each category.

Training program 132 merges combinations of log files (step 210). In an embodiment, combinations of log files are created by concatenating the log files and sorting each log file based on the timestamp. For example, if there are three log files X, Y, Z, all combinations can be: X, Y, Z, XY, XZ, YZ, and XYZ. By combining the log files, the log files become more closely related to each other, which may allow the order of events to stay in sequence. Determining combinations of each log file allows training program 132 to categorize errors without needing each of the individual log files. In an embodiment, log files are merged according to time stamps, which can help determine a root cause of failures occurring at or near the same time.

Training program 132 categorizes errors within the merged log files (step 212). In an embodiment, errors are categorized using known methods in the art, for example, running supervised machine learning such as a Markov Model over the sequential output from step 210. A Markov Model, for example, is a statistical model of sequential data. Applying machine learning on log files allows the log files that are similar to be matched or clustered. For each cluster, the type of error of the cluster must be classified, typically by a tester or developer. In an embodiment, a user can label each log file with a particular error. Errors can be, for example, a network error, a disk full error, an undefined error, or a third party application crash.

Training program 132 determines whether there are more test runs (decision block 214). If training program 132 determines there are more test runs (decision block 214, yes branch), the program retrieves additional log files from within distributed data processing environment 100 (step 202). If training program 132 determines there are no more test runs (decision block 214, no branch), training program 132 completes the training (step 216). In an embodiment, training program 132 completes training by providing a user with a notification that the training is complete and the trained data contains error categorizations developed using multiple test log files.

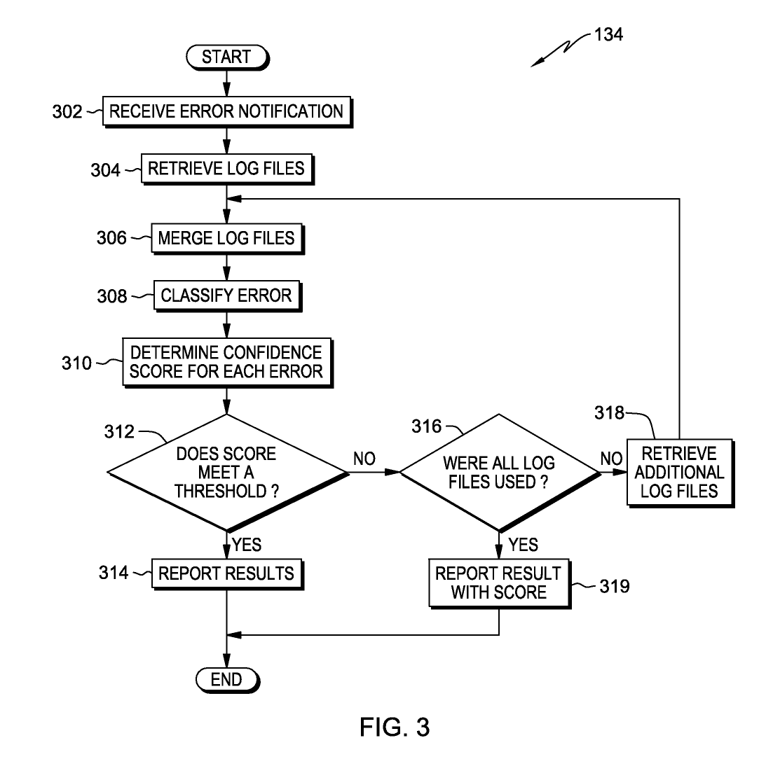

FIG. 3 is a flowchart depicting operational steps of reporting program 134 for classifying errors based on the categorized log files from operation of training program 132 and determining a confidence score associated with the classified errors, in accordance with an embodiment of the present invention.

Reporting program 134 receives an error notification during a test run (step 302). In an embodiment, a notification of an error is received from within distributed data processing environment 100, for example, from software program 124 which can send an error to reporting program 134 on server computing device 130 via network 110. In an alternate embodiment of the present invention, an error notification can come from any device or application within distributed data processing environment 100, or from a tester or developer operating within the environment 100. In various other embodiments, reporting program 134 determines an error occurred during a test run based on text analysis of log files.

Reporting program 134 retrieves initial log files (step 304). In an embodiment, initial log files associated with the error during test can be retrieved directly from the components and applications being tested as well as from database 122 via network 110. Log files can be test case log files, product log files, or cloud log files from various applications and components within distributed data processing environment 100.

Reporting program 134 merges the log files based on a time stamp (step 306). In an embodiment, reporting program 134 correlates and merges log files to create combinations, for example, by concatenating the log files and sorting each log file based on the timestamp, as discussed above with reference to FIG. 2, step 210.

Reporting program 134 classifies errors based on the data obtained from the operation of training program 132 (step 308). In an embodiment, reporting program 134 uses the categorized errors determined using training program 132, in order to classify the errors found during the test run. Errors can be, for example, a network failure, a notification that a disk is full, or a third party application crash.

Reporting program 134 determines a confidence score for each error (step 310). In an embodiment, if there is available training data that corresponds to the errors received in the current test run, reporting program 134 determines a classification of the errors and an associated confidence score for the error classification. In embodiments, the machine learning algorithm used to train the data in training program 132 can be used to determine the confidence score. Depending on the algorithm used, each machine learning algorithm can provide a probability of whether the current log file matches any log files found in a particular cluster created during the training (at step 212). In an embodiment, the confidence score is determined based on how statistically close the most recent log files (obtained during the current test) are as compared to the test log files used to develop the training data. Reporting program 134 determines how statistically close the most recent log files are to the test log files using known methods, such as natural language processing or another text analysis comparison method, to determine a statistical similarity value of how similar the log files are to each other. Reporting program 134 sets the confidence score based on the similarity value. For example, if the most recent log files are 75% similar to the test log files, then a threshold confidence score may be set at 75%. If the most recent log files are only 25% similar to the test log files, the threshold confidence score may be set at 25%.

Reporting program 134 determines if the confidence score meets a threshold value (decision block 312). In an embodiment, threshold values for an error classification confidence score can be configured by a user or operator of the system. For example, a user may set a high confidence score at 75%. If the confidence score meets or exceeds the established threshold value, for example, 75% or higher (decision block 312, “yes” branch), then the results will be reported to a user, tester, or developer within distributed data processing environment 100 (step 314). Once the errors are reported, processing ends.

If reporting program 134 determines the confidence score does not meet the threshold (decision block 312, “no” branch), reporting program 134 determines whether each available log file from the test run is being used (decision block 316). If reporting program 134 determines each available log file is used (decision block 316, “yes” branch), reporting program 134 reports the results in addition to the confidence score (step 319). In an embodiment, reporting program 134 reports the results to a user, e.g., a tester or developer, to allow the user to classify the error. In an alternate embodiment, results may be reported by reporting program 134, even if a user is unavailable to classify the errors.

If reporting program 134 determines each available log file from the test run was not used (decision block 316, “no” branch), reporting program 134 retrieves additional log files within distributed data processing environment 100 (step 318). In an embodiment, additional log files can be prioritized, based on the time stamp of the log file, to determine which log file is more likely to improve the confidence score, i.e., a higher priority log file may provide a better classification of an error than a lower priority log file. After additional log files have been retrieved, reporting program 134 merges the additional log files (step 306) and repeats in order to potentially determine another classification of the error and an associated confidence score.

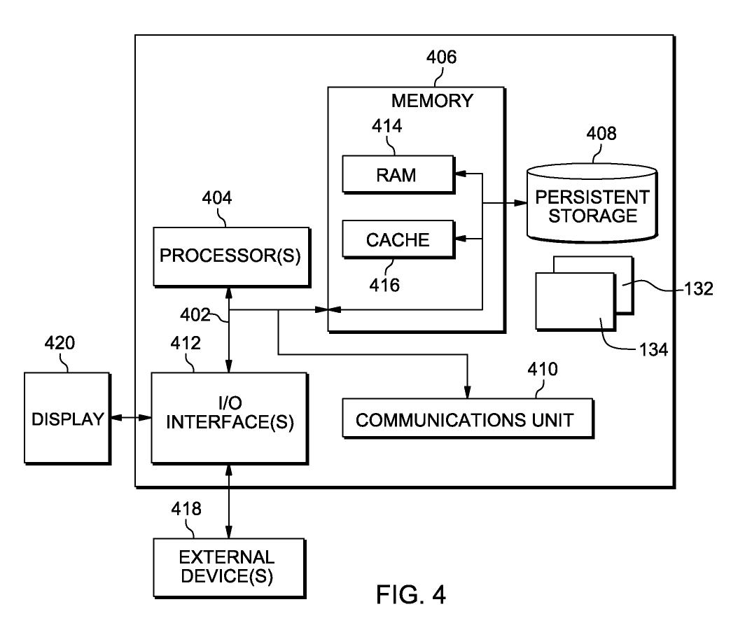

FIG. 4 depicts a block diagram of components of server computing device 130, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Server computing device 130 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Training program 132 and reporting program 134 may be stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, a read-only memory (ROM), an erasable programmable read-only memory (EPROM), a flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including between client computing devices 120a to n and server computing device 130. In these examples, communications unit 410 includes one or more network interface cards. Communications unit 410 may provide communications through the use of either or both physical and wireless communications links. Training program 132 and reporting program 134 may be downloaded to persistent storage 408, or another storage device, through communications unit 410.

I/O interface(s) 412 allows for input and output of data with other devices that may be connected to server computing device 130. For example, I/O interface 412 may provide a connection to external device(s) 418 such as a keyboard, a keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., training program 132 and reporting program 134, can be stored on such portable computer readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining a classification of an error in a computing system, the method comprising:
receiving, by one or more computer processors, a notification of an error during a test within a computing system;
retrieving, by one or more computer processors, a plurality of log files created during the test from within the computing system;
determining, by one or more computer processors, data containing one or more error categorizations; and
determining, by one or more computer processors, a classification of the error, based, at least in part, on the plurality of log files and the data containing one or more error categorizations.

2. The method of claim 1, further comprising:
determining, by one or more computer processors, a confidence score associated with the classification of the error.

3. The method of claim 2, further comprising:
determining, by one or more computer processors, whether the confidence score meets a threshold value; and
responsive to determining the confidence score meets the threshold value, reporting, by one or more computer processors, the classification of the error.

4. The method of claim 3, further comprising:
responsive to determining the confidence score does not meet the threshold value, determining, by one or more computer processors, whether additional log files created during the test exist;
responsive to determining additional log files created during the test exist, retrieving, by one or more computer processors, the additional log files; and
determining, by one or more computer processors, a second classification of the error, based, at least in part, on the plurality of log files, the data containing one or more error categorizations, and the additional log files.

5. The method of claim 4, further comprising:
responsive to determining additional log files created during the test do not exist, reporting, by one or more computer processors, the classification of the error and the confidence score associated with the classification of the error.

6. The method of claim 1, wherein determining, by one or more computer processors, data containing one or more error categorizations further comprises:
retrieving, by one or more computer processors, a plurality of test log files from a test within the computing system;
parsing, by one or more computer processors, the plurality of test log files to obtain a timestamp of each log file;
merging, by one or more computer processors, the plurality of test log files based, at least in part, on the timestamp; and
categorizing, by one or more computer processors, one or more errors contained in each of the merged plurality of test log files.

7. The method of claim 6, wherein the categorizing, by one or more computer processors, one or more errors contained in each of the merged plurality of test log files further comprises performing, by one or more computer processors, a machine learning algorithm operation on each of the merged plurality of test log files.

8. The method of claim 2, wherein determining, by one or more computer processors, the confidence score associated with the classification of the error further comprises:
determining, by one or more computer processors, a plurality of test log files used to determine the data containing one or more error categorizations;
comparing, by one or more computer processors, the plurality of log files created during the test to the plurality of test log files used to determine the data containing one or more error categorizations;
determining, by one or more computer processors, based, at least in part, on the comparing, a similarity value between the plurality of log files created during the test and the plurality of test log files; and
responsive to determining the similarity value between the plurality of log files created during the test and the plurality of test log files, setting, by one or more computer processors, the confidence score, based, at least in part, on the similarity value.
